(19) United States
(12) Patent Application Publication
(10) Pub. No.: US 2019/0294093 A1
(43) Pub. Date: Sep. 26, 2019

(54) IMAGE FORMING APPARATUS, NOTIFICATION APPARATUS, AND NOTIFICATION METHOD

(71) Applicants: KABUSHIKI KAISHA TOSHIBA, Tokyo (JP); TOSHIBA TEC KABUSHIKI KAISHA, Tokyo (JP)

(72) Inventor: Takayuki Sadakuni, Numazu Shizuoka (JP)

(21) Appl. No.: 15/933,461

(22) Filed: Mar. 23, 2018

(51) Int. Cl. G03G 15/00; G06F 3/12

(52) U.S. Cl. CPC G03G 15/50; G06F 3/121; G03G 15/5004

(57) ABSTRACT

The image forming apparatus according to the embodiment includes a first sensor unit, a setting unit, and a notification unit. The first sensor unit is configured to detect a person who enters a detection range and specify a position of the person. If an error related to image processing or image formation occurs, the setting unit is configured to set a notification direction according to the position of the person who enters the detection range. The notification unit is configured to notify an occurrence of the error in the notification direction based on setting by the setting unit.

### FIELD

Embodiments described herein relate generally to an image forming apparatus, a notification apparatus, and a notification method.

### BACKGROUND

In an image forming apparatus such as a multifunction peripheral (MFP), when an error occurs, the occurrence of an error is notified by light emission of a light-emitting diode (LED), output of a beep sound or the like. However, if there is no user near the image forming apparatus when the error occurs, the user may not notice the error. Also, the user may not also notice the error in the same manner in other apparatuses without being limited to the image forming apparatus.

### DESCRIPTION OF THE DRAWINGS

FIG. 1 is a block diagram illustrating an example of a circuit configuration of main parts of an image forming apparatus according to an embodiment.

FIG. 2 is a flowchart of processing according to the embodiment performed by a processor in FIG. 1.

FIG. 3 is a diagram for explaining the image forming apparatus according to the embodiment.

### DETAILED DESCRIPTION

The image forming apparatus according to an embodiment includes a first sensor unit, a setting unit, and a notification unit. The first sensor unit is configured to detect a person who enters a detection range and specifies a position of the person. If an error related to image processing or image formation occurs, the setting unit is configured to set a notification direction according to the position of the person who enters the detection range. The notification unit is configured to notify the occurrence of an error in the notification direction based on setting by the setting unit.

Hereinafter, an image forming apparatus according to an embodiment will be described with reference to the drawings.

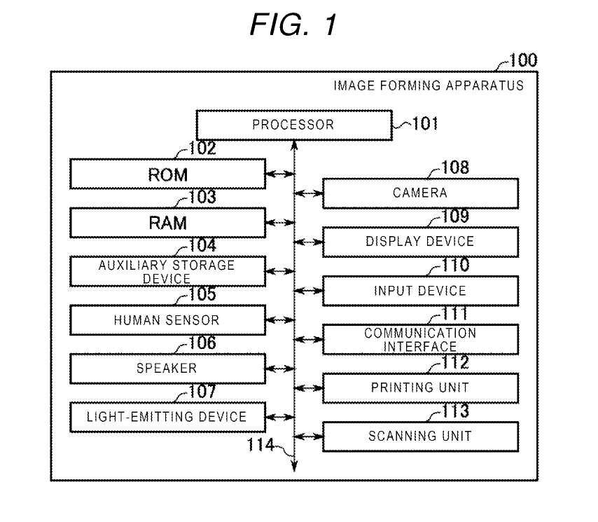

FIG. 1 is a block diagram illustrating an example of a circuit configuration of main parts of an image forming apparatus 100 according to an embodiment.

An image forming apparatus 100 is, for example, an MFP, a copier, a printer, a facsimile, or the like. The image forming apparatus 100 has, for example, a print function, a scan function, a copy function, a decolorizing function, a facsimile function, and the like. The print function is to use a recording material such as a toner for an image forming medium or the like to form an image. The image forming medium is, for example, a sheet-like paper. The scan function is to read an image from an original document or the like on which the image is formed. The copy function is to print an image read from the original document or the like using the scan function on the image forming medium using the print function. The decolorizing function is to decolorize an image, which is formed by a decolorable recording material, on the image forming medium. As an example, the image forming apparatus 100 includes a processor 101, a read-only memory (ROM) 102, a random-access memory (RAM) 103, an auxiliary storage device 104, a human sensor 105, a speaker 106, a light-emitting device 107, a camera 108, a display device 109, an input device 110, a communication interface 111, a printing unit 112, a scanning unit 113, and a bus 114.

The processor 101 corresponds to a central portion of a computer that performs processing such as computation and control necessary for the operation of the image forming apparatus 100. The processor 101 controls each unit to realize various functions of the image forming apparatus 100 based on a program such as system software, application software, or firmware stored in the ROM 102, the auxiliary storage device 104, and the like. The processor 101 includes, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 101 is a combination of a plurality of these components. The processor 101 is an example of the setting unit.

The ROM 102 corresponds to a main storage device of a computer having the processor 101 as the central portion. The ROM 102 is a nonvolatile memory exclusively used for reading data. The ROM 102 stores the program described above. The ROM 102 stores data used by the processor 101 for performing various processing or setting values.

The RAM 103 corresponds to a main storage device of a computer having the processor 101 as the central portion. The RAM 103 is a memory used for reading and writing data. The RAM 103 is used as a so-called work area or the like for storing data temporarily used by the processor 101 for performing various processing.

The auxiliary storage device 104 corresponds to an auxiliary storage device of the computer having the processor 101 as the central portion. The auxiliary storage device 104 is, for example, an electric erasable programmable read-only memory (EEPROM), a hard disk drive (HDD), a solid state drive (SSD), or the like. The auxiliary storage device 104 may store the program described above. The auxiliary storage device 104 stores data used by the processor 101 for performing various processing, data generated due to the processing by the processor 101, various setting values, and the like. The image forming apparatus 100 may be provided with an interface into which a storage medium such as a memory card or a universal serial bus (USB) memory can be inserted instead of the auxiliary storage device 104 or in addition to the auxiliary storage device 104.

The program stored in the ROM 102 or the auxiliary storage device 104 includes a program for executing processing to be described later. As an example, the image forming apparatus 100 is transferred to an administrator or the like of the image forming apparatus 100 in a state where the program is stored in the ROM 102 or the auxiliary storage device 104. However, the image forming apparatus 100 may be transferred to the administrator or the like in a state where the program is not stored in the ROM 102 or the auxiliary storage device 104. In the image forming apparatus 100, a program different from the program may be transferred to the administrator or the like while being stored in the ROM 102 or the auxiliary storage device 104. A program for executing processing to be described later is separately transferred to the administrator or the like and may be written into the ROM 102 or the auxiliary storage device 104 under the operation of the administrator or service personnel or the like. Transfer of the program at this case can be realized by recording the program on a removable storage medium such as a magnetic disk, a magneto-optical disk, an optical disk, a semiconductor memory or the like, and otherwise, downloading via a network NW.

The human sensor 105 is provided to detect that a person enters a predetermined range. The human sensor 105 measures and outputs, for example, a physical quantity that varies depending on the distance to a person. The human sensor 105 measures, for example, a direction in which a person is present and a distance to the person and identifies the position of the person. The human sensor 105 performs measurement by, for example, an electromagnetic wave such as infrared ray, visible light or radio wave, ultrasonic wave, or a combination thereof. The human sensor 105 preferably measures by using ultrasonic waves. This is because it is easy to measure a wide range of angles by using ultrasonic waves.

The speaker 106 outputs an input sound signal as a sound wave. The speaker 106 is preferably a directional speaker such as a parametric speaker. The speaker 106 is an example of a notification unit.

The light-emitting device 107 is, for example, a laser device emitting such as light of an LED, an incandescent lamp or a fluorescent lamp, or laser. When the light-emitting device 107 is a light, it is preferable to use a light-emitting device capable of converging a light flux by a reflection plate or a lens. Accordingly, the light-emitting device 107 has directivity. The light-emitting device 107 is an example of the notification unit.

The camera 108 captures an image or a moving image. The camera 108 is provided so that an image of a person approaching the image forming apparatus 100 can be captured.

The display device 109 displays a screen for notifying the operator of the image forming apparatus 100 of various pieces of information. The display device 109 is, for example, a display such as a liquid crystal display or an organic electro-luminescence (EL) display.

The input device 110 receives an operation of the image forming apparatus 100 by an operator. The input device 110 is, for example, a keyboard, a keypad, a touch pad, or the like. As the display device 109 and the input device 110, a touch panel can also be used. That is, a display panel included in the touch panel can be used as the display device 109, and a touch pad included in the touch panel can be used as the input device 110.

The communication interface 111 is an interface through which the image forming apparatus 100 communicates with another apparatus via a network such as the Internet or a local area network (LAN), a bus such as USB, or wireless communication or the like.

The printing unit 112 prints an image on the image forming medium by forming an image or the like on the image forming medium using a toner, ink, or the like. The printing unit 112 is, for example, a laser printer, an ink jet printer, or another type of printer.

The scanning unit 113 reads an image from the original document. The scanning unit 113 includes a scanner for reading an image from the original document. The scanner is, for example, an optical reduction type scanner including an image-capturing element such as a charge-coupled device (CCD) image sensor. Alternatively, the scanner is a contact image sensor (CIS) type scanner including an image-capturing element such as a complementary metal-oxide-semiconductor (CMOS) image sensor. Otherwise, the scanner is another known type scanner.

The bus 114 includes a control bus, an address bus, a data bus, and the like, and transmits signals transmitted and received by each unit of the image forming apparatus 100.

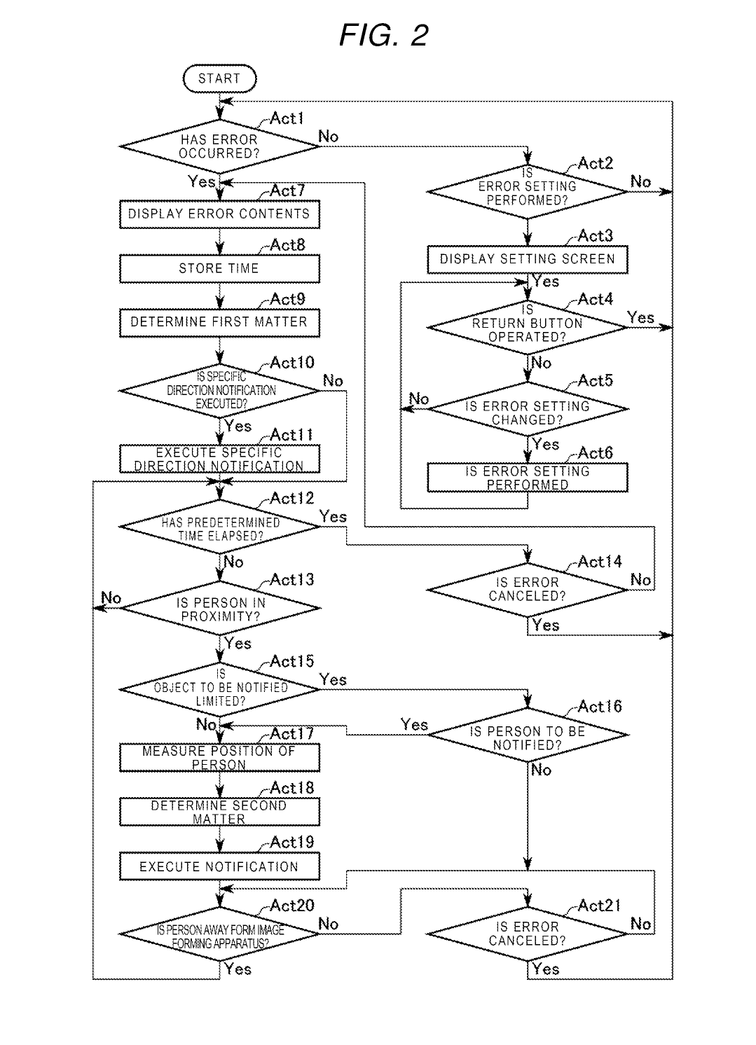

Hereinafter, the operation of the image forming apparatus 100 according to the embodiment will be described with reference to FIG. 2. The contents of processing in the following operation description is merely an example, and various processing capable of obtaining the same result can be appropriately used. FIG. 2 is a flowchart of processing by the processor 101 of the image forming apparatus 100. The processor 101 executes the processing based on a program stored in the ROM 102 or the auxiliary storage device 104 or the like. When the processor 101 proceeds to Act (N+1) after processing of Act N (N is a natural number), description that explains for proceeding thereof may be omitted in some cases.

In Act 1 of FIG. 2, the processor 101 determines whether an error occurs or not. When it is determined that an error does not occur, the processor 101 determines that a determination result in Act 1 is No and proceeds to Act 2. Examples of the error include errors relating to image formation or image processing, such as paper jam, service call, use-up of paper, forgetting to take out a scanned original document, and forgetting to take out a printed image forming medium.

In Act 2, the processor 101 determines whether an operation for confirming and changing setting (hereinafter referred to as “error setting”) regarding the operation if an error occurs is performed or not. When it is determined that the operation for starting confirmation and change of the error setting is not performed, the processor 101 determines that a determination result in Act 2 is No and returns to Act 1. Thus, the processor 101 repeats Act 1 and Act 2 until an error occurs or the operation for starting confirmation and change of the error setting is performed.

When the operation for starting confirmation and change of the error setting is performed in the standby state of Act 1 and Act 2, the processor 101 determines that a determination result in Act 2 is Yes and proceeds to Act 3.

In Act 3, the processor 101 generates an image corresponding to a setting screen. Then, the processor 101 instructs the display device 109 to display the generated image. Upon receiving the instruction, the display device 109 displays the setting screen. In the setting screen, buttons for changing various error settings and a return button for returning to the original screen before displaying the setting screen are displayed.

In Act 4, the processor 101 determines whether the return button is operated or not. When it is determined that the return button is not operated, the processor 101 determines that a determination result in Act 4 is No and proceeds to Act 5.

In Act 5, the processor 101 determines whether an operation for instructing to change the error setting is performed or not. When it is determined that the operation for instructing the change of the error setting is not performed, the processor 101 determines that a determination result in Act 5 is No and returns to Act 4. Thus, the processor 101 repeats Act 4 and Act 5 until the return button is operated or an operation for instructing to change the error setting is performed.

When it is determined that the return button is operated in the standby state of Act 4 and Act 5, the processor 101 determines that a determination result in Act 4 is Yes and returns to Act 1.

When it is intended to change the error setting, the operator of the image forming apparatus 100 operates the input device 110 and performs an operation for instructing to change the error setting.

When it is determined that the operation for instructing to change the error setting is performed in the standby state of Act 4 and Act 5, the processor 101 determines that a determination result in Act 5 is Yes and proceeds to Act 6.

In Act 6, the processor 101 changes the error setting according to the operation content in Act 5. What kind of setting can be made in the error setting will be clarified in the description of each operation described below. When the error setting is not changed by the operator of the image forming apparatus 100, the error setting may be set to a default value by the operator or the like of the image forming apparatus 100. The error setting may include setting which cannot be changed unless the operator has a specific authority. The error setting may include setting of which value is fixed and which cannot be changed.

When it is determined that an error occurs in the standby state of Act 1 and Act 2, the processor 101 determines that the determination result in Act 1 is Yes and proceeds to Act 7.

In Act 7, the processor 101 causes the display device 109 to display the contents of the error that occurs.

In Act 8, the processor 101 stores the current time in the RAM 103 or the like. When the time has already been stored in the RAM 103, the processor 101 overwrites the time with the current time to be stored.

In Act 9, the processor 101 determines a first matter regarding notification. The first matter includes, for example, (1) whether or not to execute specific direction notification, and (2) detection range of proximity determination.

The processor 101 determines, for example, (1) whether or not to execute specific direction notification based on the following conditions (1-1) to (1-4). For example, if all of (1-1) to (1-4) conditions are satisfied, the processor 101 determines to execute the specific direction notification. What kind of an operation the specific direction notification works is will be described later.

(1-1) In which direction the specific direction notification is to be executed is determined by the error setting.

(1-2) The content of the occurring error is the content determined by the error setting when the specific direction notification is executed.

(1-3) The time from an occurrence of the error is a threshold value X1 determined by the error setting. The threshold value X1 may be a different value for each error content. The threshold value X1 may be zero.

(1-4) The time since the execution of the specific direction notification in the previous time is equal to or greater than a threshold value X2, and an error occurred when the specific direction notification was executed in the previous time is not canceled. The threshold value X2 may be a different value for each error content. A value of the threshold value X2 may change according to the time from the occurrence of the error. Also, the value of the threshold value X2 may change according to the number of times the specific direction notification is executed until the error is canceled.

The processor 101 determines (2) the detection range of proximity determination, for example, as described below, based on the contents of the error being occurred, the time from the occurrence of the error, the situation of the image forming apparatus 100, error setting, and the like. Details of the proximity determination will be described later.

The processor 101 may determine the detection range according to the content of the error occurring or may uniformly set the detection range regardless of the content of the error occurring. Whether or not to determine the detection range according to the content of the error occurring is determined by the error setting, for example. When the detection range is decided according to the content of the error occurring, the detection range for each error content is determined by the error setting, for example.

The processor 101 may determine the detection range according to the time from the occurrence of the error or may determine the detection range regardless of the time from the occurrence of the error. Whether or not to decide the detection range according to the time from the occurrence of the error is determined by the error setting, for example. In the case where the detection range is determined according to the time from the occurrence of the error, for example, the processor 101 widens the detection range as the time from the occurrence of the error becomes longer. In the case where the detection range is made wider as the time from the occurrence of the error becomes longer, the processor 101 sets the detection range to the range R1 when the time from the occurrence of the error is less than a threshold value X3-1, sets the detection range to the range R2 when the time from the occurrence of the error is equal to or greater than the threshold value X3-1 and less than a threshold value X3-2, sets the detection range to the range R3 when the time from the occurrence of the error is equal to or greater than the threshold value X3-2 and is less than a threshold value X3-3, and so on. A magnitude relationship between the threshold value X3-1, the threshold value X3-2, the threshold value X3-3, . . . is X3-1<X3-2<X3-2< . . . . Each of range R1, range R2, range R3, . . . represents the extent of the range, and the magnitude relationship therebetween is R1<R2<R3< . . . . The respective values of the threshold value X3-1, the threshold value X3-2, the threshold value X3-3 . . . and the range R1, the range R2, the range R3, . . . are determined based on the error setting, for example. When the detection range is made wider as the time from the occurrence of the error becomes longer, the processor 101 determines the detection range by a function f1 of the time from the occurrence of the error. The function f1 is determined, for example, based on the error setting.

The processor 101 may determine the detection range according to a situation of the image forming apparatus 100 or may determine the detection range regardless of the situation of the image forming apparatus 100. Whether or not to decide the detection range according to the situation of the image forming apparatus 100 is determined by error setting, for example. The situation of the image forming apparatus 100 is, for example, the number of jobs such as a print job. In the case where an error occurs, printing cannot be performed and thus, unexecuted jobs may increase. Accordingly, the processor 101 widens the detection range as the number of unexecuted jobs increases, for example. For example, the processor 101 widens the detection range by r1 when the number of jobs is equal to or greater than a threshold value X4-1 and is less than a threshold value X4-2, and widens the detection range by r2 when the number of jobs is equal to or greater than the threshold value X4-2 and is less than a threshold value X4-3, . . . . The magnitude relationship between the threshold value X4-1, the threshold value X4-2, the threshold value X4-3, . . . is X4-1<X4-2<X4-3< . . . . Also, the magnitude relationship between r1, r2, . . . is r1<r2< . . . . The respective values of the threshold value X4-1, the threshold value X4-2, the threshold value X4-3, . . . and r1, r2, . . . are determined based on the error setting, for example. The situation of the image forming apparatus 100 is, for example, the total number of printed sheets of unexecuted jobs. The processor 101 may widen the detection range as the total number of printed sheets of unexecuted jobs increases.

From the matters as described above, as an example, when the time from the occurrence of the error is equal to or greater than the threshold value X3-2 and less than the threshold value X3-3, and the number of unexecuted jobs is equal to or greater than the threshold value X4-1 and less than the threshold value X4-2, the detection range is, for example, R3+r1.

In Act 10, the processor 101 determines, based on the first matter determined in Act 10, whether the specific direction notification is to be executed or not. When it is determined that the specific direction notification is to be executed, the processor 101 determines that a determination result in Act 10 is Yes and proceeds to Act 11.

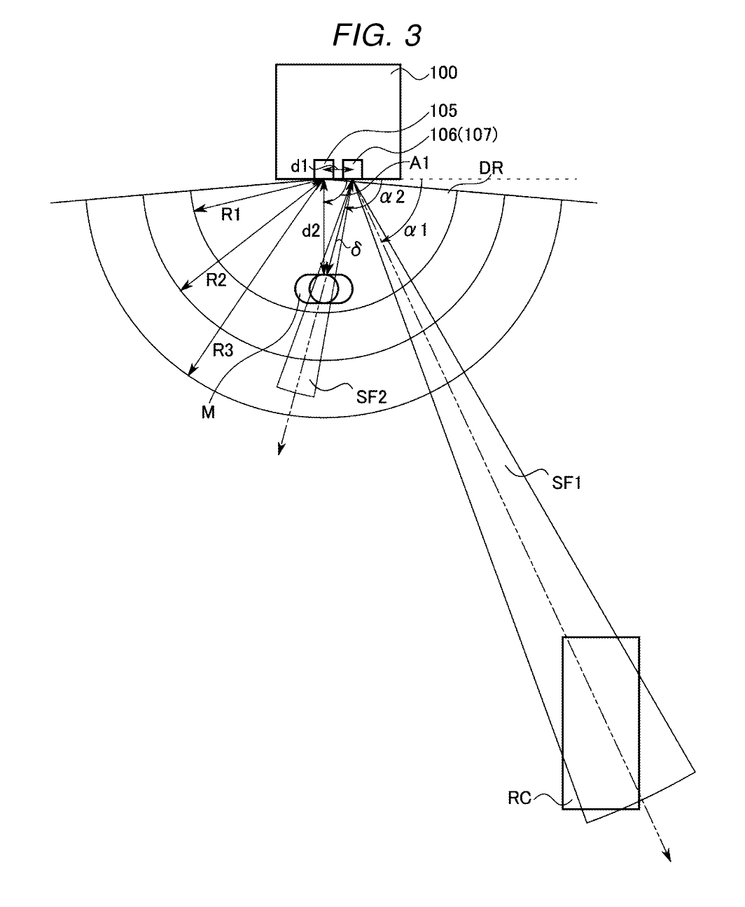

In Act 11, the processor 101 executes the specific direction notification as illustrated in FIG. 3. The specific direction notification is to notify occurrence of an error with respect to a predetermined direction (angle) α1. The direction α1 is determined, for example, by error setting. It is possible to notify a store clerk of the occurrence of the error by setting, for example, a direction in which there is a place, such as a cash register RC, where there is a high possibility of a store clerk as the direction α1. FIG. 3 is a diagram for explaining the image forming apparatus according to the embodiment.

The processor 101 notifies the specific direction notification by using at least anyone device among the speaker 106, the light-emitting device 107, and the like, for example. The device used for the specific direction notification is determined, for example, by error setting. FIG. 3 illustrates the specific direction notification by the speaker 106. The speaker 106 outputs a sound in the direction α1. With this, a sound field SF 1 is formed by the sound in the audible range with respect to the direction α1. The magnitude of the sound that the speaker 106 outputs for the specific direction notification is determined based on, for example, the error setting. In the specific direction notification, the sound output from the speaker 106 may be a simple beep sound or a melody, or may be a sound indicating the content of an error or the like.

When the processor 101 executes the specific direction notification in the direction α1 using the light-emitting device 107, the processor 101 may change the light emission pattern of the light-emitting device 107 depending on the contents of the error and the like. The light emission pattern is, for example, a color of light emitted from the light-emitting device 107 and a way of light emission. The way of light emission is, for example, a blinking pattern of light. The light emission pattern is determined, for example, by error setting.

After processing of Act 11, the processor 101 proceeds to Act 12. If the specific direction notification is not executed, the processor 101 determines that a determination result in Act 10 is No and proceeds to Act 12.

In Act 12, the processor 101 determines whether a predetermined time has elapsed from the time stored in Act 8 or not. When it is determined that the predetermined time is not elapsed from the time stored in Act 8, the processor 101 determines that a determination result in Act 12 is No and proceeds to Act 13.

In Act 13, the processor 101 determines whether a person is in proximity to the image forming apparatus 100 or not. When it is determined that the person is not in proximity to the image forming apparatus 100, the processor 101 determines that a determination result in Act 13 is No and returns to Act 12. Thus, the processor 101 repeats Act 12 and Act 13 until a predetermined time is elapsed from the time stored in Act 8 or until a person comes in proximity thereto.

If a predetermined time is elapsed from the time stored in Act 8 when it is in the standby state of Act 12 and Act 13, the processor 101 determines that the determination result in Act 12 is Yes and proceeds to Act 14.

In Act 14, the processor 101 determines whether the error that occurs is canceled and it is in a state in which no error occurs or not. When it is determined that an error does not occur, the processor 101 determines that a determination result in Act 14 is Yes and returns to Act 1. On the other hand, when it is determined that the error that occurs is not released, the processor 101 determines that the determination result in Act 14 is No and returns to Act 7. With the operation described above, the processor 101 can decide again the first matter at every predetermined time. The predetermined time is determined, for example, by the error setting.

As illustrated in FIG. 3, if the person M enters a detection range DR, the processor 101 detects that the person M enters the detection range DR based on a value output by the human sensor 105. The detection range DR is the range determined in Act 9. When the processor 101 detects that the person M is in proximity when it is in the standby state of Act 12 and Act 13, the processor 101 determines that a determination result in Act 13 is Yes and proceeds to Act 15.

From the matters described above, the processor 101 cooperates with the human sensor 105 and operates as an example of a first sensor unit that detects a person who entered the detection range.

In Act 15, the processor 101 determines whether setting is made to limit an object to be notified or not. For example, the setting is included in the error setting. To limit an object to be notified is to execute notification only if the person M who entered the detection range DR is a specific person, or if the person M is dressed specific clothes. A person to be notified and clothes to be notified are determined by the error setting, for example. Registration of a plurality of the persons to be notified and the clothes to be notified may be possible. When it is determined that setting is made to limit the object to be notified, the processor 101 determines that the determination result in Act 15 is Yes and proceeds to Act 16.

In Act 16, the processor 101 determines whether the person M who entered the detection range DR is a person to be notified or not. For example, the processor 101 determines, by image recognition using the camera 108, whether the person M is a person to be notified or not. For example, the processor 101 determines, by image recognition using the camera 108, whether the person M is dressed the clothes to be notified or not. In the image recognition, the processor 101 determines whether it is the person to be notified or the clothes o to be notified based on characteristics of the person or characteristics of the clothes. In cooperation with the camera 108, the processor 101 operates as a second sensor unit that identifies whether a person's characteristic meets a predetermined condition or not. An example of the clothes to be notified includes a uniform which is adopted at a store where the image forming apparatus 100 is installed. By using such uniforms as clothes to be notified, it is possible to notify only to the store clerk without notifying the customers. Also, by registering the face of the clerk, it is possible to notify only to the store clerk without notifying the customers.

When the clothes such as uniforms are registered, labor is reduced compared to registering the faces of all the clerks.

When it is determined that the person M is a person to be notified, the processor 101 determines that a determination result in Act 16 is Yes and proceeds to Act 17. When it is determined that the setting is not made to limit the object to be notified, the processor 101 determines that the determination result in Act 15 is No and proceeds to Act 17.

In Act 17, the processor 101 specifies the position of the person M based on the value output by the human sensor 105. The processor 101 specifies the position of the person M, for example, by measuring the direction (angle) β where the person M is present as seen from the human sensor 105 and the distance d2 from the human sensor 105 to the person M. Accordingly, the processor 101 cooperates as the human sensor 105 and operates as an example of the first sensor unit that specifies the position of a person.

In Act 18, the processor 101 determines a second matter concerning notification. The second item includes, for example, information indicating (A) which device to use for notification, (B) notification direction, (C) output level, and (D) notification content.

For example, the processor 101 determines (A) which device to use for notification based on the content of the error being occurred, the time from the occurrence of the error, the situation of the image forming apparatus 100, and the error setting. The devices used for notification includes the speaker 106, the light-emitting device 107, and the like.

The processor 101 may decide which device to use for notification according to the content of the error occurring or may decide which device to use for notification regardless of the content of the error. Whether or not to decide which device to use for notification according to the content of the error occurring is determined by the error setting, for example. When it is intended to determine which device to use for notification according to the content of the error being occurred, which device to be used for notifying each error content according to the content of the error occurring is determined based on, for example, the error setting.

The processor 101 may decide which device to use for notification according to the time from the occurrence of the error or may decide which device to use for notification regardless of the time from the occurrence of the error. Whether or not to decide which device to use for notification according to the time from the occurrence of the error is determined by the error setting, for example. When it is intended to determine which device to use for notification according to the time from the occurrence of the error, which device to be used for notifying each error content according to the time from the occurrence of the error is determined based on, for example, the error setting. For example, if the time from the occurrence of the error is less than the threshold value X5-1, the processor 101 determines the speaker 106 as a device used for notification. When the time from the occurrence of the error is equal to or greater than the threshold value X5-1, the processor 101 determines the speaker 106 and the light-emitting device 107 as the device used for notification. That is, in this case, the image forming apparatus 100 performs notification by sound while the time from the occurrence of the error is shorter than a predetermined time, and performs notification by sound and light if the time from the occurrence of the error is longer than the predetermined time. For example, if the time from the occurrence of the error is less than the threshold value X5-2, the processor 101 determines the light-emitting device 107 as a device used for notification. When the time from the occurrence of the error is equal to or greater than the threshold value X5-2, the processor 101 determines the speaker 106 and the light-emitting device 107 as the device used for notification. That is, in this case, the image forming apparatus 100 performs notification by light while the time from the occurrence of the error is shorter than a predetermined time, and performs notification by sound and light if the time from the occurrence of the error is longer than the predetermined time.

The processor 101 may decide which device to use for notification according to the situation of the image forming apparatus 100 or may decide which device to use for notification regardless of the situation of the image forming apparatus 100. Whether or not to decide which device to use for notification according to the situation of the image forming apparatus 100 is determined by the error setting, for example. The situation of the image forming apparatus 100 is, for example, the number of jobs such as a print job. For example, when the number of jobs is less than a threshold value X6, the processor 101 determines either the speaker 106 or the light-emitting device 107 as a device used for notification. Then, if the number of jobs is equal to or greater than the threshold value X6, the processor 101 determines one of the speaker 106 and the light-emitting device 107 as the device used for notification. Also, the processor 101 may determine which device to use for notification according to the total number of printed sheets of unexecuted jobs.

For example, the processor 101 determines a direction (angle) α2 in which the person M seen from the device used for notification is the (B) notification direction. For example, the processor 101 derives the direction α2 based on a direction β, a distance d2, and a distance d1 between the human sensor 105 and the device used for notification. Then, the processor 101 determines the direction α2 as the notification direction. Furthermore, the processor 101 derives a distance δ from the device used for notification to the person M based on the direction β, the distance d2 and the distance d1. Then, the processor 101 determines the (C) output level according to the magnitude of the distance δ. That is, the processor 101 increases the output level as the distance δ increases and decreases the output level as the distance δ decreases. For example, the processor 101 sets the output level to K1 when the distance δ is less than a threshold value X7-1, sets the output level to K2 when the distance δ is equal to or greater than the threshold value X7-1 and less than a threshold value X7-2, sets the output level to K3 when the distance δ is equal to or greater than the threshold value X7-2 and less than a threshold value X7-3, . . . . The magnitude relationship between the threshold value X7-1, the threshold value X7-2, the threshold value X7-3, . . . is X7-1<X7-2<X7-3< . . . . The magnitude relationship between the output level K1, the output level K2, the output level K3, . . . is K1<K2<K3< . . . . The respective values of the threshold value X7-1, the threshold value X7-2, the threshold value X7-3, . . . and the output level K1, the output level K2, the output level K3, . . . are determined based on the error setting, for example.

Alternatively, the processor 101 may determine the direction β as the notification direction, instead of the direction α2. This is because the difference between the direction in which the person M seen from the device used for the notification is present and the direction β is considered to be small, so that the direction β is regarded as the direction in which the person M seen from the device that uses the direction β for notification is present. The processor 101 may determine the output level according to the magnitude of the distance d2, instead of the distance δ. This is because the difference between the distance of the person M seen from the device used for notification and the distance d2 is considered to be small, so that the distance d2 is regarded as the distance to the person M seen from the device used for notification.

The output level is, for example, volume if the device used for notification is the speaker 106. The output level is, for example, brightness (for example, light flux, luminous intensity, luminance, and output) if the device used for notification is the light-emitting device 107.

The processor 101 may determine the output level according to the content of the error occurring. Whether or not to decide the output level according to the content of the error is determined, for example, by the error setting. Then, if the output level is determined according to the content of the error, the magnitude of the output level for each error content is determined based on, for example, the error setting.

The processor 101 may determine the output level according to the time from the occurrence of the error. For example, the processor 101 increases the output level by k1 if the time from the occurrence of the error is equal to or greater than a threshold value X8-1 and less than a threshold value X8-2, and increases the output level by k2 if the time from the occurrence of the error is equal to or greater than the threshold value X8-2 and less than a threshold value X8-3, . . . . The magnitude relationship between the threshold value X8-1, the threshold value X8-2, the threshold value X8-3, . . . is X8-1<X8-2<X8-3≤ . . . . The magnitude relationship between k1, k2, . . . is k1<k2< . . . .

From the matters described above, as an example, when the distance δ is equal to or greater than the threshold value X7-2 and less than the threshold value X7-3 and the time from the occurrence of the error is equal to or greater than the threshold value X8-2 and less than the threshold value X8-3, the output level becomes, for example, K3+k2.

For example, the processor 101 determines the (D) notification content according to the content of the error occurring. For example, if the device used for notification is the speaker 106, the processor 101 determines the content of the error or the like as the notification content to be notified by voice. When the device used for notification is the light-emitting device 107, the light emission pattern of the light-emitting device 107 is determined according to the contents of the error or the like. The determination of the light emission pattern is the determination of the notification content.

Alternatively, the processor 101 may notify the same notification content regardless of the content of the error occurring. For example, the notification content in this case is simply a beep sound or a melody when the device used for notification is the speaker 106. In this case, when the device used for notification is the light-emitting device 107, the notification content is the way of light emission and the like.

In Act 19, the processor 101 executes notification based on the second matter determined in Act 18. For this, the processor 101 controls the speaker 106, the light-emitting device 107, and the like.

After processing of Act 19, the processor 101 proceeds to Act 20. When the person M is not the notification target, the processor 101 determines that the determination result in Act 16 is No and proceeds to Act 20.

In Act 20, the processor 101 determines whether a person is away from the image forming apparatus 100 or not. For example, the processor 101 determines that a person has left when a state in which a value output by the human sensor 105 is equal to or less than a constant value continues for a predetermined time or longer. When it is determined that the person is not away therefrom, the processor 101 determines that a determination result in Act 20 is No and proceeds to Act 21.

In Act 21, the processor 101 determines whether or not the error that occurs is canceled and it is in a state where an error does not occur. When it is determined that the error that occurs is canceled and it is in a state where an error does not occur, the processor 101 determines that the determination result in Act 21 is No and proceeds to Act 20. Thus, the processor 101 repeats Act 20 and Act 21, in which a person is away from the image forming apparatus 100 or an error that occurs is not canceled.

When it is determined that a person is away from the image forming apparatus 100 when it is in the standby state of Act 20 and Act 21, the processor 101 determines that the determination result in Act 20 is Yes and proceeds to Act 12.

Also, when it is in the standby state of Act 20 and Act 21, if the error does not occur, the processor 101 determines that the determination result in Act 21 is Yes and returns to Act 1.

The image forming apparatus 100 according to the embodiment outputs sound or light in the direction of a person when the person enters the detection range if an error occurs. With this, the person is easily notice that an error occurs.

When a person enters the detection range if an error occurs, the image forming apparatus 100 according to the embodiment outputs sound or light at an output level corresponding to the distance to the person. That is, the image forming apparatus 100 can output sound or light with an appropriate sound volume or light brightness.

The image forming apparatus 100 according to the embodiment changes the detection range according to the content of the error. For example, the image forming apparatus 100 can make it easy for the user to notice that a serious error occurs by widening the detection range as the more serious error occurs.

The image forming apparatus 100 of the embodiment changes the output level according to the contents of the error. For example, the image forming apparatus 100 can make it easy for the user to notice that a serious error occurs by increasing the output level as the more serious error occurs.

The image forming apparatus 100 according to the embodiment changes the detection range according to the situation of the image forming apparatus 100. For example, if the image forming apparatus 100 is in a situation where it is necessary to deal with an error earlier, the image forming apparatus 100 can make the detection range wider so as to make it easy for the user to notice that an error occurs.

The image forming apparatus 100 according to the embodiment changes the output level according to the situation of the image forming apparatus 100. For example, if the image forming apparatus 100 is in a situation where it is necessary to deal with an error earlier, the image forming apparatus 100 can increase the output level so as to make it easy for the user to notice that an error occurs.

The image forming apparatus 100 according to the embodiment changes the detection range according to the time from the occurrence of the error. The image forming apparatus 100 can prevent the time until the error is canceled from being lengthened, for example, by widening the detection range as the time from the occurrence of the error is longer.

The image forming apparatus 100 according to the embodiment changes the output level according to the time from the occurrence of the error. The image forming apparatus 100 can prevent the time until the error is canceled from being lengthened, for example, by increasing the output level as the time from the occurrence of the error is longer.

When an error occurs, the image forming apparatus 100 executes specific direction notification and there is a possibility that sound or light may reach outside of the detection range in the specific direction notification. Accordingly, there is a possibility that the image forming apparatus 100 can inform the user of the occurrence of an error before the user enters the detection range. By determining the direction in which a person is highly likely present as the direction of specific direction notification, the possibility increases.

The image forming apparatus 100 performs notification by using a directional speaker. Accordingly, the image forming apparatus 100 can output sound so that the sound can be heard only by a person in the detection range.

The image forming apparatus 100 performs notification by using a light emission pattern by the light-emitting device. As a result, the image forming apparatus 100 can notify even those who cannot hear the sound. The image forming apparatus 100 can notify even where the sound cannot be emitted. Further, the image forming apparatus 100 can make the user notice even in a place with a lot of noise.

The embodiment described above can also be modified as follows.

The image forming apparatus 100 may measure the position of the person M who enters the detection range in real time. Then, the image forming apparatus 100 may change the notification direction in real time according to the position of the person M measured in real time. By doing as described above, even if the person M who enters the detection range is moving, it is possible to continue to notify the direction in which the person M is present.

The camera 108 may also serve as the human sensor 105. In this case, the processor 101 performs image analysis on the image or moving images captured by the camera 108 to detect the fact that the person M comes in proximity, the distance to the person M, and the direction in which the person M is present. In this case, the camera 108 constitutes the first sensor unit, instead of the human sensor 105.

The human sensor 105 may be constituted with a plurality of sensors. In the embodiment described above, the human sensor 105 detects that a person enters the detection range, and the human sensor 105 also specifies the position of the person. However, the human sensor 105 may include at least two types of sensors of a sensor for detecting that a person enters the detection range and a sensor for specifying the position of a person.

The image forming apparatus 100 may change the content of notification depending on the person to be notified. For example, the processor 101 changes the second matter regarding notification for a person M who is a registered person or a person who is dressed pre-registered clothes and for a person M who is a person not registered or a person who is dressed clothes which are not registered.

In the embodiment described above, an image forming apparatus is described as an example. However, the same operation as in the embodiment described above can be applied as the operation if an error occurs in an apparatus other than the image forming apparatus. Examples of such devices include point-of-sale (POS) terminals, digital signage, vending machines, various electrical appliances, personal computers (PC), server devices, and industrial machinery. These devices to which the same operation as the embodiment described above are applied are examples of the notification apparatus.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An image forming apparatus comprising:
a processor that executes instructions to facilitate performance operations, comprising:
detecting a person who enters a detection range and specifying a position of the person;
setting a notification direction according to the position of the person who enters the detection range in response to an occurrence of an error related to image processing or image formation; and
notifying an occurrence of the error in the notification direction, via use of a directional notification device, based on the position of the person.

2. The apparatus according to claim 1, wherein the operations further comprise,
setting at least one of a size of the detection range and an output level based on at least one of an error content and a situation of the image forming apparatus.

3. The apparatus according to claim 1, wherein the operations further comprise,
setting at least one of a size of the detection range and an output level based on a time from the occurrence of the error.

4. The apparatus according to claim 1, wherein the operations further comprise,
setting an output level based on a position of the person.

5. The apparatus according to claim 1, wherein the operations further comprise:
setting the notification direction to a predetermined direction in response to the error, and
notifying the occurrence of the error in the predetermined direction.

6. The apparatus according to claim 1, wherein the operations further comprise:
identifying whether or not characteristics of the person meet a predetermined condition,
performing notification if the characteristics of the person meet the predetermined condition.

7. The apparatus according to claim 1, wherein the directional notification device is a directional speaker, and wherein the operations further comprise,
performing notification by using sound output by the directional speaker.

8. The apparatus according to claim 1, wherein the directional notification device is a light-emitting device, and wherein the operations further comprise,
performing notification by using a light emission pattern by the light-emitting device.

9. A notification apparatus comprising:
a processor that executes instructions to facilitate performance of operations, comprising:
detecting a person who enters a detection range and specifying a position of the person;
setting a notification direction according to the position of the person who enters the detection range in response to an occurrence of an error; and
notifying an occurrence of the error in the notification direction, via use of a directional notification device, based on the position of the person.

10. A notification method comprising:
detecting, by a device comprising a processor, a person who enters a detection range and specifying a position of the person;
setting, by the device, a notification direction according to the position of the person who enters the detection range in response to an occurrence of an error related to image processing or image formation; and
notifying, by the device, the occurrence of the error in the notification direction, via use of a directional notification device, based on the position of the person.
